(19) United States
(12) Patent Application Publication
(10) Pub. No.: US 2014/0302616 A1
(43) Pub. Date: Oct. 9, 2014

(54) METHOD AND DEVICE FOR DETERMINING PROPERTIES OF GAS PHASE BASES OR ACIDS

(71) Applicant: UNIVERSITY OF HELSINKI, UNIVERSITY OF HELSINKI (FI)

(72) Inventors: Mikko Sipila, Helsinki (FI); Heikki Junninen, Helsinki (FI)

(73) Assignee: UNIVERSITY OF HELSINKI, University of Helsinki (FI)

(21) Appl. No.: 14/358,406

(22) PCT Filed: Nov. 15, 2012
(86) PCT No.: PCT/FI2012/051126

§ 371 Date: May 15, 2014

Related U.S. Application Data
(63) Continuation of application No. 13/296,983, filed on Nov. 15, 2011, now abandoned.

(51) Int. Cl. G01N 27/62

(52) U.S. Cl. CPC G01N 27/62
USPC 436/173; 422/83

(57) ABSTRACT

Properties, such as concentrations, of gas phase bases or acids of a gas sample are determined by providing a sample gas flow, which includes the bases or acids to be determined as sample constituents, as well as also interfering constituents, which are other constituents than the sample constituents. Reagent ions are provided and introduced into the sample gas flow to arrange proton transfer reaction and thereby forming sample ions. Also a dopant is introduced into the sample gas flow to arrange proton transfer reaction between the dopant and the interfering ions thereby forming dopant ions and electrically neutral interfering constituents. For determination the gas flow with the sample ions to be determined is introduced together with the dopant ions to a mass spectrometer in order to determine the properties of the gas phase bases or acids.

### TECHNICAL FIELD OF THE INVENTION

The invention relates to a method and device for determining properties, such as masses or concentrations, of gas phase bases or acids.

### BACKGROUND OF THE INVENTION

An accurate mass spectrometry methods for determining of properties of gas phase bases or acids are in very important role e.g. in atmospheric studies, such as studying e.g. roles of ammonia and amines in atmospheric nanoparticle formation. Especially there is a need for better known of low concentrations and variability of atmospheric amines as well as also many other bases and acids.

Methods for determining properties of gas phase bases or acids by a mass spectrometer are known from prior art. When using the mass spectrometer sample constituents must be charged before analysis. The ion flow of sample constituents may be achieved e.g. by chemical ionizing the sample constituents using a proton transfer reaction. For example patent application GB2324406 discloses a very typical method for obtaining an ion flow composed of NH₄⁺ ions from a mixture of different ionisation products produced by ionisation of ammonia. There the ionisation products are left in a chamber in which ammonia is present at a pressure about 0.01 torr, until the ionisation products which are initially other than NH₄⁺ are converted into NH₄⁺ ions. An electric field must be used to prevent formation of cluster ions.

In a proton transfer reaction the ionisation of a neutral component A takes place by transferring a proton from a proton donor. The proton affinity, Eₚₐ, of an anion or of a neutral atom or molecule is a measure of its gas-phase basicity. It is the energy released in a reaction of molecule with a proton: A+H⁺→AH⁺.

It is known that excess proton tend to transfer to compound with higher proton affinity AH⁺ +B→A+BH⁺ if EₚₐA<EₚₐB. The reaction does not necessarily happen in every collision, but depends e.g. on structures of molecules, difference of proton affinities, etc.

When measuring relatively low proton affinity gases (e.g. VOCs) and being as quantitative as possible, one should know that vapour tend to cluster on top of an ion. In addition the proton affinity of a cluster can be significantly higher, which is a problem if the proton affinity of sample compound is smaller than primary ion cluster. Thus clustering should be prevented especially if difference between proton affinities of primary ion and sample compound is small. This is typically why the prior art methods are implemented in a low pressure, so in order to break clusters. Low pressure besides makes the density of vapor capable to cluster smaller, but also allows to give enough kinetic energy to clusters by means of electric field, that they can be broken up in collisions with the gas molecules. However, when the low pressure is used a collision rate of the sample components and proton donors/acceptors will be ineffective.

When using an electric field to prevent clustering, it unfortunately induces another problem in a form of an electrostatic breakthrough. In order to break possible clusters to bare molecular ions, ion collision energies of the order e.g. of about 0.2-0.4 eV or even more (depending on the cluster in question) are needed, when the limit of electrostatic breakthrough in air at ambient pressure correspond to ion kinetic energy about 0.2 eV, and at 2 torr about 1 eV.

Nevertheless, there is still another problem when ionizing the sample constituents by proton transfer reaction, and detecting the ionized sample with a mass spectrometer. The problem arises because the proportion of the atmospheric sample constituents under interest and to be determined may be very low in relation to all other constituents in the sample volume having the same integer mass. If those other, interfering compounds get ionized by proton transfer their signal often obscure the signal from said atmospheric sample constituents under interest. In some examples, the signal from the ionized atmospheric sample constituent to be detected contributes only about or even below few % to the total signal at the same integer mass (or mass-to-charge) channel of the mass spectrometer and cannot be separated from interfering ion signal without extremely high mass resolution.

### SUMMARY OF THE INVENTION

An object of the invention is to alleviate and eliminate the problems relating to the known prior art. Especially the object of the invention is to provide a method and device to determining properties, such as masses or concentrations, of gas phase bases or acids, such as especially atmospheric ammonia, amines, sulphuric acid, nitric acid, organic acids, etc. as an example, but not limiting to only those. In particularly an object is to achieve clear peaks in the spectrum of the mass spectrometer for the sample constituents of said gas phase bases or especially low concentrated acids to be determined so that the other constituents would not disturb the measurement. In addition an object is to provide an environment with a very high and effective collision rate of the sample constituents and proton donors/acceptors.

The object of the invention can be achieved by the features of independent claims. The invention relates to a method according to claim 1. In addition the invention relates to a device according to claim 17.

According to an embodiment of the invention for determining properties, such as masses or concentrations, of gas phase bases or (low concentrated) acids of a gas sample, a sample gas flow is provided. The sample gas flow comprises at least the atmospheric bases or acids to be determined as sample constituents, but always also interfering constituents. The interfering constituents comprise as an example other constituents than sample constituents to be determined, so constituents not wanted to be determined.

According to an embodiment reagent ions are provided in order to be introduced into the sample gas flow and again to arrange proton transfer reaction between said reagent ions and at least sample constituents thereby forming sample ions. It is to be noted that there also happens possibly proton transfer reaction between the reagent ions and the interfering constituents thereby forming interfering ions.

The reagent ions may be provided e.g. by ionizing candidate reagent constituents typically by an ion source, such as e.g. Am-241, Po-210 or X-ray ion source. Water is one example of the candidate reagent constituent, but the invention is not limited only to water as the candidate reagent constituent. According to an example water is configured to form water cluster after ionization.

According to an advantageous embodiment of the invention a dopant is introduced into the sample gas flow after introducing said reagent ions in order to arrange proton transfer reaction between said dopant and the interfering ions thereby forming dopant ions and interfering constituents (being again electrically neutral). Thus the charging of the interfering ions will be discharged and they are not determined in the mass spectrometer. By using an appropriate dopant most or even all of the constituents not wanted to be determined (so interfering constituents) may be avoided and the peaks determined belong essentially only to the sample constituent interested and the dopant ions. Acetone is one good example of the dopant in a gas phase, but also ethanol or propanol may be used, for example.

After introducing said dopant the gas flow is introduced at least with said sample ions to be determined to the mass spectrometer in order to determine the properties of said atmospheric bases or acids. Anyway also the interfering constituents are traversed in the gas flow to the mass spectrometer. However, because only the sample constituents interested remain charged, only they are detected by the mass spectrometer (together with dopant ions) and not the discharged interfering constituents, because the mass spectrometer is not sensitive for discharged (electrically neutral) constituents.

According to an embodiment the method can be applied for the bases. When applied for the bases, the candidate reagent constituents are then chosen so that the proton affinity of the candidate reagent constituents is smaller than the proton affinity of the dopant and/or sample constituents, whereupon the ionized candidate reagent constituents transfer protons at least to the sample constituents thus ionizing them, so forming sample ions. In addition the dopant is chosen so that its proton affinity is smaller than the proton affinity of the sample constituents, whereupon the dopant receives protons from the interfering ions thereby forming dopant ions and discharging interfering ions.

When applied for the bases, the candidate reagent constituent may comprise water, and the dopant may comprise acetone, ethanol or propanol, as an example. However, the invention is not limited to only those, but also numerous other reagent constituents are possible, such as even methanol or benzene. According to another example the reagent constituent could be even ammonia (very high affinity), and no dopant or dopant with extremely high affinity is used. Still with some examples dopant can even be ammonia or even some amine.

According to an embodiment the method can be applied for the acids. When applied for the acids, the candidate reagent constituents are chosen so that the proton affinity of candidate reagent constituents is greater than the proton affinity of the dopant and/or sample constituents, whereupon the negatively charged candidate reagent (missing a proton) constituents receive protons at least from the sample constituents in said proton transfer reaction between the reagent ions and the sample constituents thereby forming sample ions. In addition the dopant is chosen so that its proton affinity is greater than the proton affinity of said sample constituents, whereupon the dopant transfers protons to the interfering ions thereby forming dopant ions.

When applied for the acids, the candidate reagent constituent may comprise for example, acetic acid (acetate ion is capable of ionizing a large variety of compounds) and the dopant (if any) may comprise, e.g. some organic acid, as an example.

According to an advantageous embodiment the chemical ionization process is implemented essentially at atmospheric pressure. This increases the collision rate and thus reaction rates of the reagent ions with the constituents and thereby makes the ionization process much effective.

According to an exemplary embodiment the mass spectrometer is preferably a time-of-flight mass spectrometer (TOF) with an atmospheric pressure interface (APi), where an ion's mass-to-charge ratio is determined via a measurement of time that it subsequently takes for the particle to reach a detector at a known distance. The knowledge of the exact mass of ions helps in identifying the constituents. Mass accuracy of APi-TOF may be e.g. 0.02 mTh/Th (20 ppm). Besides the mass accuracy, also high resolution is required. The resolution of APi-TOF may be 3000 m/Δm, for example. Of course it is to be noted that also other types of mass spectrometers may be used and that the invention is not limited only to TOF-spectrometers.

According to an embodiment the sample gas flow is provided to flow inside a flow tube. Advantageously the walls of the flow tube are electropolished in order to reduce wall effects so offering much less surface for constituents to be sticking. In addition the flow may be configured to be as laminar as possible in order to minimize the contacts of the sample constituents with the walls. Furthermore, in an exemplary embodiment, also an activation vapour may be introduced to the sample gas flow or to the tube so that the activation vapour will interact with the flow tube. The activation vapour is advantageously chosen so that when contacting with the walls it retains any sample constituents into the wall if the sample constituents interact with the wall. This minimized the possibility that the sample constituent contacted with the wall might unstick from the wall later and thereby disturb the later measurement. The activation vapour may be nitric acid, as an example.

Still according to an exemplary embodiment an electric field may be generated for interacting with the flow in order to break possible clusterized constituents in the flow at least to some extent.

The present invention offers advantages over the known prior art, such as the possibility to measure accurately e.g. concentrations of atmospheric bases or acids, which proportions of the all constituents of whole atmospheric gas constituents in the sample flow is very minimal In addition the invention enables online measurement and high time resolution even at the same time. Moreover the measurements can be done in atmospheric pressure, which increases (when compared to the prior art solutions with very low measuring pressure) the collision rate of the reagent ions with the sample particles and thereby makes the ionization process much effective so that even an order of ppq particle concentrations can be measured [ppq, parts-per-quadrillion, 10⁻¹⁵].

The exemplary embodiments presented in this text are not to be interpreted to pose limitations to the applicability of the appended claims. The verb “to comprise” is used in this text as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 illustrates a table of proton affinities of some atmospheric gases as an example,

FIG. 2 illustrates an exemplary working principle of the method for determining atmospheric gas constituents according to an advantageous embodiment of the invention,

FIG. 3 illustrates a principle of an exemplary device for determining atmospheric gas constituents according to an advantageous embodiment of the invention,

FIGS. 4a, 4b illustrate a principle of an exemplary drift tube used in the device according to an advantageous embodiment of the invention, and

FIG. 5 illustrates exemplary measurement peaks for some atmospheric gas constituents (Diethyl amine+unknown interfering sample constituent; both, of course ionized) determined by the device according to an advantageous embodiment of the invention.

### DETAILED DESCRIPTION

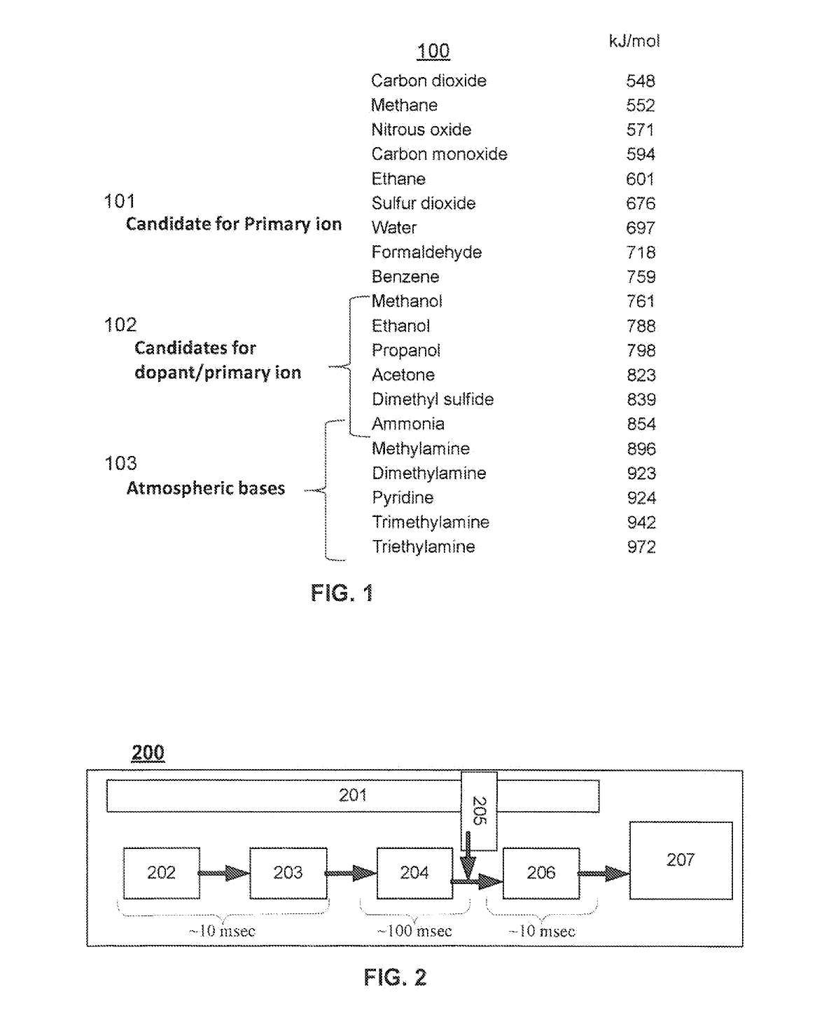

FIG. 1 illustrates a table 100 of proton affinities of some atmospheric gases as an example. For determining e.g. gas phase atmospheric bases 103, such as ammonia and amines for example, water 101 can be used as a candidate for primary ion according to an exemplary embodiment of the invention. Water is ionized and thereby provided as a reagent ion [(H₃O⁺(H₂O)ₙ] in to the gas flow comprising at least constituents to be determined, such as atmospheric bases 103 in this example. In addition the gas flow typically comprises also interfering constituents, such as Formaldehyde, Benzene, Methanol, Ethanol, Propanol, etc.

Water as a reagent ion transfers its proton to a constituent, which proton affinity is higher than water, such as to Formaldehyde, Benzene, Methanol, Ethanol, Propanol as interfering constituents, but also to the atmospheric bases (Ammonia, Methylamine, Pyridine, Trimethylamine, Triethylamine, etc.) to be interested. Thus the flow then comprises both sample ions but also interfering ions as charged particles.

According to an advantageous embodiment of the invention a dopant is used to “clear” the interfering ions from the sample gas flow. The candidate for dopant 102 (but possibly also for primary ion according to an exemplary embodiment of the invention) is chosen so that its proton affinity is smaller than the proton affinity of the sample ions to be determined, but higher than the proton affinity of interfering ions, whereupon the dopant receives excess protons from the interfering ions thus discharging them, after which the sample flow comprises essentially only sample ions as charged particles in addition to the dopant ions.

For example when considering to determine atmospheric bases 103, even over 99% of all interfering constituents can be cleared from the sample gas flow by the embodiments of the invention so that they will not induce any peaks on the mass spectrometer. Thus essentially the only peaks achieved by the mass spectrometer are for atmospheric bases to be determined and for the dopant.

FIG. 2 illustrates an exemplary working principle 200 of the method for determining atmospheric gas constituents according to an advantageous embodiment of the invention, where in steps 202-203 reagent ions are generated and guided to the sample gas flow advantageously using a drift tube. An exemplary time for steps 202-203 is about 10 ms according to an example, but it should advantageously be as short as possible so that primary ions do not have time to react any potential contaminants in the air inside the ion source. After steps 202-203 the proton transfer reaction happens between the reagent ions and sample constituents. It is noticed according to an example that 100 ms is typically enough so that at least essentially all (H₃O⁺(H₂O))ₙ have reacted. In step 205 the dopant (if any) is introduced into the sample gas flow, whereupon the proton transfer reaction between said dopant and charged interfering ions happens in step 206, which typically and according to an example takes about 10 ms (when assuming the dopant concentration to be about 0.01-1 ppm). However, it is to be noted that the time slots presented here are only exemplary and only for certain arrangements and that the invention is not limited to those.

It is also to be noted that wall effects can be minimized e.g. by wall activation (introducing activation vapour into the gas flow such as acidification) in step 201, which step (activation) can last along the whole process of determination. While acidifying the sample gas flow, care needs to be taken that no gas phase reactions between the activation vapour and sampled bases or acids will occur.

After all, the steps 201-206 enable a clear spectrum detection e.g. with a mass spectrometer in step 207 or any other suitable detector device, by which the concentration the sample ion will be obtained either by comparing signals between sample ion and dopant ion and using offline calibration, or online calibration using isotopically labeled compounds, for example.

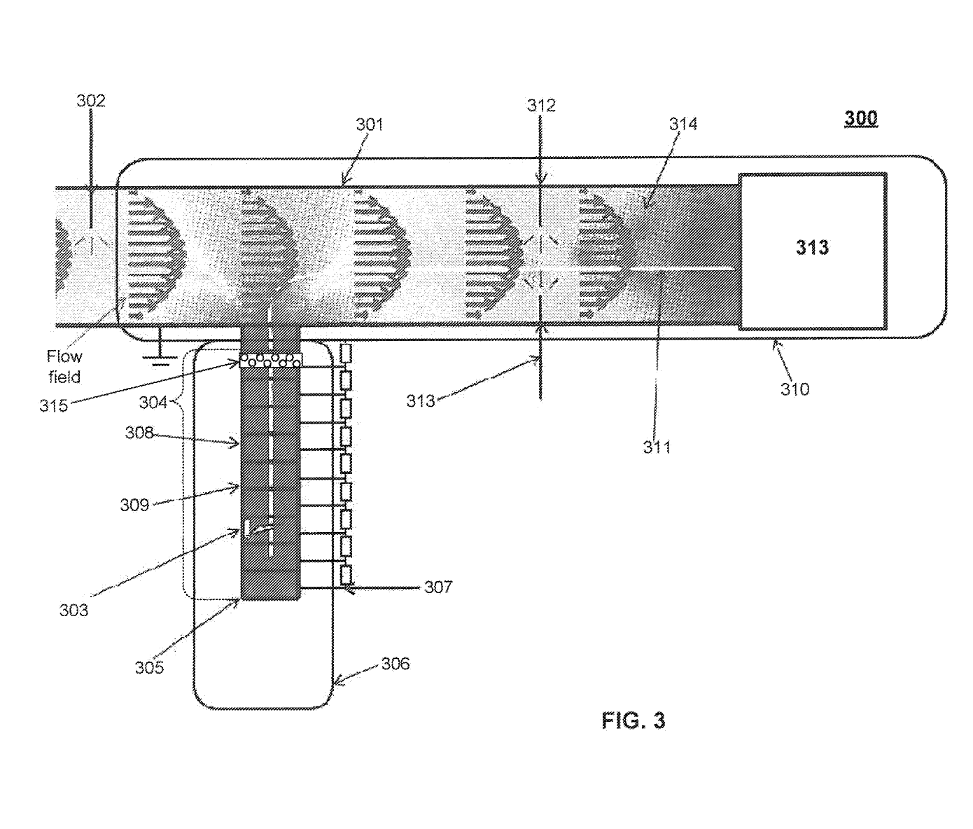

FIG. 3 illustrates a principle of an exemplary device 300 for determining properties, such as masses or concentrations, of gas phase bases or concentrated acids of a gas sample according to an advantageous embodiment of the invention. The device comprises a flow tube 301 via which the sample gas flow is flown. The inner walls (faced to the flow) of the flow tube may be electropolished to reduce wall effects so to provide much less surface for amine sticking, whereupon the wall activation is not necessarily even needed. However, if the activation is applied the device then also comprise means 302, such as a needle, and other accompanied introducing means for introducing the activation vapour (e.g. nitric acid) into the flow.

In addition the device advantageously comprises also an ion source 303 for generating reagent ions by ionizing candidate reagent constituents, such as water molecules. The ion source 303 may be e.g. Am-241, Po-210 or X-ray source as an example, and it is advantageously arranged in connection with a drift tube 304 (either inside drift tube or outside drift tube, as long as air inside drift tube gets ionized). The candidate reagent constituents (e.g. in liquid form) are arranged advantageously reservoir 305, which may be temperature controlled 306. According to an embodiment the drift tube as such may be temperature controlled 306. As an example the reservoir may contain water (or other candidate), which is heated by the temperature controller 306. The vapour is then conducted into the drift tube and especially for the ionization by the ion source.

The drift tube 304 is used for guiding reagent ions out from the ion source in reasonable time (fast), which is achieved by an electric field. According to an embodiment and only as an example, E ˜10 kV/m can be used, whereupon with about ˜0.1 m geometry, a residence time is about 0.01 s, when the collision probability with impurity X is roughly 1e-11*[X] (˜10 ppb is max allowed impurity level in the ion source (stuff reacting with reagent ion)).

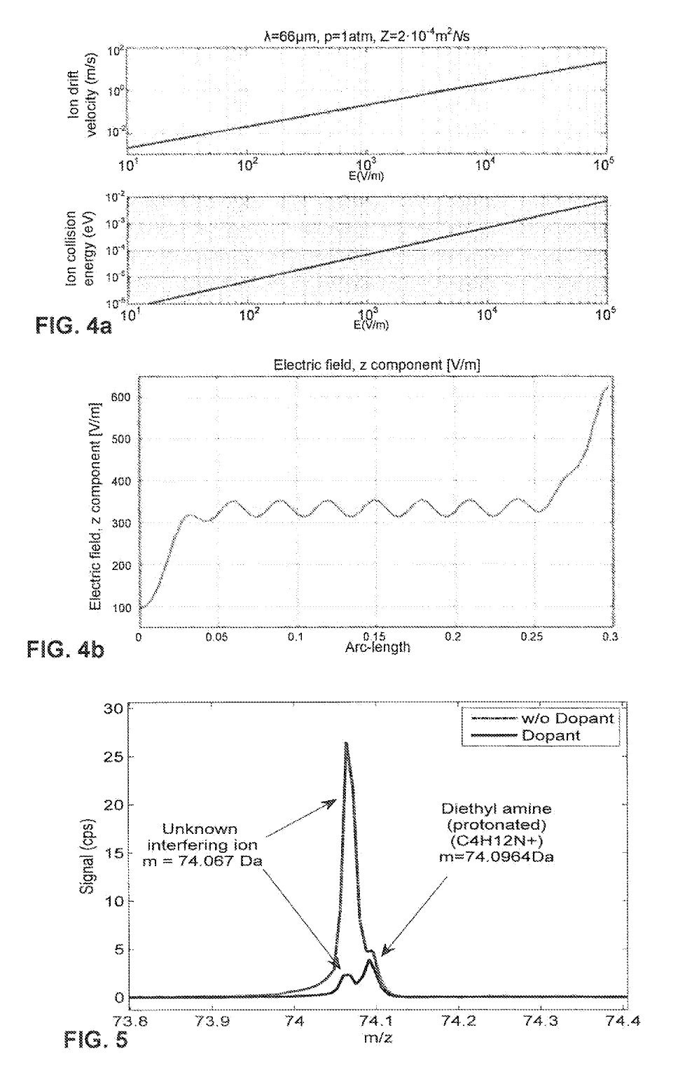

The drift tube 304 with continuous axial voltage gradient causes a quite uniform electric field in an axial direction (see e.g. in FIG. 4b). If the drift tube voltage chances in steps and if flow is laminar or zero, radial components of field slightly also focus ions towards the center of the drift tube, possibly decreasing diffusion losses. For providing the electric field the device either comprises or is connected to a power supply supplying an appropriate voltage via the voltage distribution means 307. In addition the drift tube 304 comprises sequentially stainless steel rings 308 and insulation rings 309 advantageously of ceramic or otherwise inert material to provide said drift tube with continuous axial voltage gradient. According to an exemplary embodiment the thickness of the stainless steel rings is about 8-9 mm and of the insulation rings about 1-2 mm.

The flow tube 301 may be grounded, but it may also be applied as a drift tube if the ions will be swept. The principle is analogous than with the drift tube 304. In addition the flow tube 301 may be provided with a temperature controller 310. The line 311 depicts an ion trajectory. It is to be noted that the sample flow is tried to keep as laminar as possible in order to avoid wall collision with the sample ions.

In addition the device comprises an introducing means 312, such as a needle, for introducing a dopant into the sample gas flow. The dopant may be e.g. ethanol or acetone in a gas phase, as an example. In addition the device 300 may comprise an interface 313 for the detector or any other detecting arrangement, such as an Atmospheric Pressure Intrerface for Time of Flight mass spectrometer (APi-TOF) (however, this is only as an example and the invention is not limited to this). The theoretically detection limits of about ˜ppq is possible with an exemplary arrangement. As an example, for sulfuric acid CI-API-TOF detection limits is now 5e3/cc ˜0.1 ppq for 1 h integration.

In addition the device may comprise optionally means 314 for generating an electric field in order to break possible clusterized constituents in the flow.

Furthermore according to an embodiment the device 300 may also comprise a removing means 315 advantageously in the drift tube 304 for removing possible unwanted particles diffused or otherwise leaked from the sample gas flow into the drift tube. The particles from the sample gas flow may contaminate the drift tube and thus their access into the drift tube should be prevented or minimized. As an example the removing means 315 may be implemented by an area of small holes or apertures arranged advantageously around the upper portion (the portion nearest the sample gas flow tube 301, as an example at the distance of 5-20% of the length of the drift tube from the sample gas flow tube) of the drift tube. The removal effect of the removing means 315 may be achieved by introducing underpressure into the removing means 315 so that the possible unwanted particles from the sample gas flow is drained or sucked from the upper portion of the drift tube by the partial vacuum before they reach and contaminate the drift tube.

FIGS. 4a and 4b illustrate a principle of an exemplary drift tube used in the device according to an advantageous embodiment of the invention, where in FIG. 4a an exemplary drift velocity and collision energy vs. electric field at atmospheric pressure can be seen for an exemplary ion. In addition in FIG. 4b illustrates an exemplary continuous axial voltage gradient of the tube with, which causes a quite uniform electric field in axial direction.

FIG. 5 illustrates exemplary measurement peaks for certain atmospheric gas constituents—in this case diethyl amine and unknown interfering sample constituent; both, of course ionized—determined by the device according to an advantageous embodiment of the invention. Exact mass of protonated diethyl amine is 74.0964 Da. The unknown interfering ion has a mass of approximately 74.067 Da, and it often obscures the signal from protonated diethyl amine, despite the reasonably high resolution of the APi-TOF mass spectrometer used to analyze the sample ions. When dopant (here acetone) is fed to the system, the interfering ion signal almost completely vanishes and leaves the signal associated to the sample ion to be analysed. Only now the accurate measurement of the mass and thus reliable determination of the chemical composition as well as the concentration of the sample ion becomes possible.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

1-26. (canceled)

27. A method for determining properties, comprising masses or concentrations, of gas phase bases or acids of a gas sample, wherein the method comprises following steps:
providing the sample gas flow comprising at least said atmospheric bases or acids to be determined as sample constituents and in addition also interfering constituents, said interfering constituents comprising other constituents than sample constituents to be determined,
providing reagent ions,
introducing said reagent ions into the sample gas flow in order to arrange proton transfer reaction between said reagent ions and at least sample constituents thereby forming sample ions, and/or also between the reagent ions and the interfering constituents thereby forming interfering ions,
introducing a dopant into the sample gas flow after said reagent ions in order to arrange proton transfer reaction between said dopant and the interfering ions thereby forming dopant ions and/or interfering constituents, and
introducing said gas flow at least with said sample ions to be determined to a mass spectrometer in order to determine said properties of said atmospheric bases or acid.

28. The method according to claim 27, wherein the reagent ions are provided by ionizing candidate reagent constituents by an ion source, comprising Am-241, Po-210, or X-ray source, and introduced into the sample gas flow via a drift tube, said drift tube having axial voltage gradient configured to cause an electric field in an axial direction of said tube.

29. The method according to claim 28, wherein proton affinity of candidate reagent constituents is smaller than the proton affinity of said dopant and/or sample constituents and wherein the proton affinity of said dopant is smaller than the proton affinity of said sample constituents.

30. The method according to claim 29, wherein the reagent ions are configured to transfer protons at least to the sample constituents in said proton transfer reaction between the reagent ions and the sample constituents thereby forming sample ions.

31. The method according to claim 30, wherein said dopant is configured to receive protons from the interfering ions thereby forming dopant ions.

32. The method according to claim 28, wherein said candidate reagent constituent comprises water and said dopant comprises acetone or ethanol.

33. The method according to claim 28, wherein the proton affinity of candidate reagent constituents is greater than the proton affinity of said dopant and/or sample constituents and wherein the proton affinity of said dopant is greater than the proton affinity of said sample constituents.

34. The method according to claim 33, wherein the reagent ions are configured to receive protons at least from the sample constituents in said proton transfer reaction between the reagent ions and the sample constituents thereby forming sample ions.

35. The method according to claim 34, wherein said dopant is configured to transfer protons to the interfering ions thereby forming dopant ions.

36. The method according to claim 28, wherein said candidate reagent constituent comprises acetic acid, and said dopant comprises any organic acid.

37. The method according to claim 27, wherein a chemical ionization process is implemented essentially at atmospheric pressure.

38. The method according to claim 27, wherein said mass spectrometer is a time-of-flight mass spectrometer.

39. The method according to claim 27, wherein the sample gas flow is configured to flow inside a flow tube, and wherein the walls of the flow tube are electropolished in order to reduce wall effects.

40. The method according to claim 27, wherein activation vapour is introduced to the sample gas flow in order interact with the flow tube, and wherein said activation vapour is configured to retain any sample constituents into the wall if said sample constituents interacts with said wall.

41. The method according to claim 27, wherein an electric field is generated in order to break possible clusterized constituents in the flow.

42. The method according to claim 27, wherein particles diffused or otherwise leaked from the sample gas flow into the drift tube are removed using underpressure introduced into the upper surrounding portion of the drift tube.

43. A device for determining properties, comprising masses or concentrations, of gas phase bases or concentrated acid of a gas sample, wherein the device comprises:
a flow tube for via which the sample gas flow is configured to flown, the sample gas comprising at least said atmospheric bases or acids to be determined as sample constituents and in addition also interfering constituents, said interfering constituents comprising other constituents than sample constituents to be determined,
an ion source for providing reagent ions and introducing said reagent ions into the sample gas flow in order to arrange proton transfer reaction between said reagent ions and at least sample constituents thereby forming sample ions, but also between the reagent ions and the interfering constituents thereby forming interfering ions,
an introducing device for introducing a dopant into the sample gas flow after said reagent ions in order to arrange proton transfer reaction between said dopant and the interfering ions thereby forming dopant ions, and
wherein the device is configured to introduce said gas flow at least with said sample ions to be determined to a mass spectrometer in order to determine said properties of said atmospheric bases or acid.

44. The device according to claim 43, wherein the reagent ions are provided by ionizing candidate reagent constituents by said ion source, comprising Am-241, Po-210, or X-ray source, and introduced into the sample gas flow via a drift tube, said drift tube having axial voltage gradient configured to cause an electric field in an axial direction of said tube.

45. The device according to claim 43, wherein a chemical ionization process is configured to be implemented essentially at atmospheric pressure.

46. The device according to claim 43, wherein said mass spectrometer is a time-of-flight mass spectrometer.

47. The device according to claim 43, wherein the walls of the flow tube are electropolished in order to reduce wall effects.

48. The device according to claim 43, wherein the device is configured to introduce activation vapour to the sample gas flow in order to interact with the flow tube, and thereby to retain any sample constituents into the wall if said sample constituents interacts with said wall.

49. The device according to claim 43, wherein the device comprises a temperature controlled reservoir for candidate reagent constituents in order to vaporize said candidate reagent constituents.

50. The device according to claim 43, wherein the device comprises a drift tube to introduce said reagent ions into the sample gas flow, where said drift tube comprises alternately conducting rings, such as stainless steel rings, and insulator rings, such as ceramic or otherwise inert insulator ring, and wherein said drift tube electrodes for generating electric field in order to electromagnetically transfer said ions via said drift tube into the sample gas flow.

51. The device according to claim 43, wherein the device comprises device for generating an electric field in order to break clusterized constituents in the flow.

52. The device according to claim 43, wherein the device comprises a removing device introducing underpressure into the upper surrounding portion of the drift tube for removing particles diffused or otherwise leaked from the sample gas flow into the drift tube.
